(19) United States
(12) Patent Application Publication
(10) Pub. No.: US 2020/0241524 A1
(43) Pub. Date: Jul. 30, 2020

(54) INTELLIGENT AREA AND DISPERSAL MANAGEMENT USING AUTONOMOUS VEHICLES

(71) Applicant: International Business Machines Corporation, Armonk, NY (US)

(72) Inventors: ANDREA BRITTO MATTOS LIMA, Sao Paulo (BR); Dario Augusto Borges Oliveira, Rio de Janeiro (BR); Maysa Malfiza Garcia de Macedo, Sao Paulo (BR); Igor Cerqueira Oliveira, Sao Paulo (BR)

(73) Assignee: International Business Machines Corporation, Armonk, NY (US)

(21) Appl. No.: 16/259,605

(22) Filed: Jan. 28, 2019

(51) Int. Cl. G05D 1/00; B64C 39/02; G06K 9/00; G06F 16/587; A01B 79/00

(52) U.S. Cl. CPC G05D 1/0027; G05D 1/0022; B64C 39/024; B64C 2201/127; G06F 16/587; A01B 79/005; B64C 2201/128; G06K 9/00657

(57) ABSTRACT

In a precision agriculture application, using an imagery task constraint corresponding to an image capture task, an autonomous vehicle (AV) is selected to perform the task. The AV is caused to perform the task according to the imagery task constraint, causing the AV to autonomously record image data of an area in a field of view of the AV. Image data responsive to the task is received from the AV. From analysis of the image data using a processor and a memory, a material distribution task and a corresponding distribution task constraint are generated. Using the distribution task constraint, a second AV to perform the material application task is selected. The second AV is caused to perform the material distribution task according to the distribution task constraint, causing the autonomous vehicle to autonomously trigger dispersal of a material in an area in a field of view of the autonomous vehicle.

### TECHNICAL FIELD

The present invention relates generally to a method, system, and computer program product for intelligent management of a physical area. More particularly, the present invention relates to a method, system, and computer program product for intelligent area and dispersal management in precision agriculture using autonomous vehicles.

### BACKGROUND

Hereinafter, an autonomous vehicle (AV) includes any ambulatory machine that can set itself in motion to travel from one geographical point to another point (auto-propulsion) on surface, in air, or through water. Examples of AV include but are not limited to self-driving automobiles, ambulatory robotic entities, self-propelled drones, and many other manifestations. A reference to a vehicle herein is a reference to an AV unless expressly disambiguated where used.

An autonomous terrestrial vehicle (ATV) moves itself in contact with a surface of the earth, while an autonomous aerial vehicle (AAV) moves itself at any height above the surface of the earth. As used herein, an ATV and an AAV are each a subset of the term autonomous vehicle. An autonomous vehicle uses various in-vehicle sensors to determine the vehicle's location and avoid obstacles while proceeding to a destination. An autonomous vehicle often includes a sensor with which to monitor an environment that might be too risky, inconvenient, or inefficient for humans to access. An autonomous vehicle often includes an actuator with an ability to place a physical material into an environment, or remove a physical material from an environment, that might be too risky, inconvenient, or inefficient for humans to access.

### SUMMARY

The illustrative embodiments provide a method, system, and computer program product. An embodiment includes a method that selects, using an imagery task constraint corresponding to an image capture task, an autonomous vehicle (AV) to perform the image capture task. The embodiment causes the autonomous vehicle to perform the image capture task according to the imagery task constraint, performing the image capture task comprising causing the AV to autonomously record image data of an area in a field of view of the AV. The embodiment receives, from the AV, image data responsive to the imagery task. The embodiment generates, from an analysis of the image data using a processor and a memory, a material distribution task and a corresponding distribution task constraint. The embodiment selects, using the distribution task constraint, a second AV to perform the material application task. The embodiment causes the second AV to perform the material distribution task according to the distribution task constraint, performing the material distribution task comprising causing the autonomous vehicle to autonomously trigger dispersal of a material in an area in a field of view of the autonomous vehicle.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for intelligent area and dispersal management using autonomous vehicles in accordance with an illustrative embodiment;

FIG. 4 depicts a block diagram of an example configuration for intelligent area and dispersal management using autonomous vehicles in accordance with an illustrative embodiment;

FIG. 5 depicts a block diagram of an example configuration for intelligent area and dispersal management using autonomous vehicles in accordance with an illustrative embodiment;

FIG. 6 depicts an example of intelligent area and dispersal management using autonomous vehicles in accordance with an illustrative embodiment;

FIG. 7 depicts another example of intelligent area and dispersal management using autonomous vehicles in accordance with an illustrative embodiment;

FIG. 8 depicts a flowchart of an example process for intelligent area and dispersal management using autonomous vehicles in accordance with an illustrative embodiment;

FIG. 9 depicts another flowchart of an example process for intelligent area and dispersal management using autonomous vehicles in accordance with an illustrative embodiment; and FIG. 10 depicts another flowchart of an example process for intelligent area and dispersal management using autonomous vehicles in accordance with an illustrative embodiment.

### DETAILED DESCRIPTION

The illustrative embodiments recognize that autonomous vehicles, while capable of performing specific tasks, are not capable of determining which specific task should be performed, when that specific task should be performed, where, or under what conditions. To illustrate, consider an agricultural area such as a farm. A farm manager might send an autonomous vehicle to record a set of images of a field having particular latitude and longitude coordinates. An autonomous vehicle, given this task, would proceed to the specified coordinates and record the specified images. However, most autonomous vehicles are not capable of determining that images should be recorded in the first place, which field should be imaged, on what day or time the field should be imaged, what weather conditions are appropriate for imaging, and whether the autonomous vehicle is capable of obtaining images from the correct point of view.

As well, an autonomous vehicle is not capable of determining whether a specific task would be better performed by a different autonomous vehicle having a different set of capabilities. One task might require accessing an environment from the ground, while another task might require accessing an environment from the air. For example, when managing a farm, an ATV may be best suited to collect a soil sample, while an AAV may be best suited to image the top of a tree.

As well, an autonomous vehicle is not capable of executing a task, not executing a task, altering a task, or otherwise deviating from a planned workflow. In particular, an autonomous vehicle is not capable of determining that a second task should be performed based on the results of the first task. Continuing the farm management example, suppose the autonomous vehicle records the specified images. However, the autonomous vehicle is not capable of determining that the images are inadequate and a different set of images should be recorded, or that data in the set of images indicates that a fertilizer application is necessary.

Consequently, the illustrative embodiments recognize that there is a need for intelligent management of a physical area that generates a task for an autonomous vehicle, evaluates a result of the task, and generates a new task according to the result.

The illustrative embodiments recognize that the presently available tools or solutions do not address these needs or provide adequate solutions for these needs. The illustrative embodiments used to describe the invention generally address and solve the above-described problems and other problems related to intelligent area and dispersal management using autonomous vehicles.

An embodiment can be implemented as a software application. The application implementing an embodiment can be configured as a modification of an existing area management or autonomous vehicle control system, as a separate application that operates in conjunction with an existing area management or autonomous vehicle control system, a standalone application, or some combination thereof.

Particularly, some illustrative embodiments provide a method by which a monitoring task can be generated, an appropriate autonomous vehicle selected to perform the monitoring task, the selected autonomous vehicle caused to perform the monitoring task, the results of the performance analyzed to generate a material distribution task, an appropriate autonomous vehicle selected to perform the material distribution task, and the selected autonomous vehicle caused to perform the material distribution task.

An embodiment generates one or more tasks. A task, as used herein, is a unit of work performed by an autonomous vehicle. An embodiment also accepts a task from a user. An embodiment also accepts a higher-level task from a user, and generates a corresponding set of more detailed tasks. For example, a generated task, when managing a farm, might be to obtain X images of a location bounded by a set of geographical coordinates. A user might provide this same task. Instead, a user might provide progressively higher-level tasks, such as, “get X images of field A” (where field A has a known set of geographical coordinates), “determine if field A is ready for planting”, and “when field A is ready for planting, plant it with plant X, plant Y, or plant Z, whichever is most appropriate to current soil conditions, predicted weather throughout the growing season, and predicted market conditions when each plant will be ready to harvest”.

Another embodiment uses an agricultural information database to generate tasks, alone or in combination with tasks from a user. The agricultural information database can include information such as conditions that are appropriate for planting various types of plants, nutrient and moisture requirements of various types of plants, and when and how such plants should be harvested. Using the database, an embodiment generates tasks to obtain data on current field conditions, determines from the resulting data that current field conditions match criteria for planting, applying nutrients, harvesting, or other area management needs, and generates additional tasks to perform those needs.

An imagery task is a type of monitoring task. An imagery task causes an autonomous vehicle to record, using a sensor of the autonomous vehicle, an image of an environment around the autonomous vehicle. An environment recording task, also a type of monitoring task, causes an autonomous vehicle to record, using a sensor of the autonomous vehicle, an aspect of an environment around the autonomous vehicle. For example, one environment recording task might be to record sounds, or sounds within a particular frequency range or time period, within a particular environment. Another environment recording task might be to record electromagnetic signals within a particular frequency range and time period, within a particular environment. Another environment recording task might be to record a temperature of a portion of a particular environment. Another environment recording task might be to record a moisture level of a portion of a particular environment. For example, when managing a farm, one imaging task might be to obtain an overhead view of a particular orchard, and another imaging task might be to obtain a side view of the stems of a particular row of a particular field of plants. One environment recording task might be to record a soil temperature at a particular depth below the surface of a particular field, and another environment recording task might be to record a moisture level of the air at a particular height above the surface of a particular field.

A sample collection task, also a type of monitoring task, causes an autonomous vehicle to collect a physical sample of a portion of an environment around the autonomous vehicle. Depending on the capabilities of the autonomous vehicle, the AV can return the sample to a designated area for further analysis or perform the analysis at the collection site. For example, when managing a farm, one sample collection task might be to collect a series of soil samples, from specified locations, on which soil analysis—such as for moisture or nutrient content—can be conducted. Another sample collection task might be to collect a series of leaf samples to analyze to help determine plant health. Another sample collection task might be to collect a sample fruit, vegetable, or other agricultural product to determine proper product development and whether the product requires irrigation, a fertilizer application, or is ready for harvesting. Given an AV of sufficient capability, a sample collection task might also be to actually harvest the agricultural product.

A material distribution task causes an autonomous vehicle to apply a physical material to a portion of an environment around the autonomous vehicle or to modify a portion of an environment around the autonomous vehicle. For example, when managing a farm, one material distribution task might be to use an actuator on an autonomous vehicle to plow the soil in a particular field. Another material distribution task might be to distribute seeds or fertilizer over a particular area.

An AV maintenance task cause an autonomous vehicle to perform a maintenance task on itself, or to proceed to a designated area where a human or another system can perform maintenance on the AV. Some example maintenance tasks are performing a self-diagnosis routine to provide current status information to an inquiring AV management system, performing an sensor calibration, such as a camera calibration, against a known signal or image to ensure that subsequent data collection using the sensor remains within a predetermined accuracy range, and proceeding to a designated location for refueling, recharging, or loading of a physical material to be applied as part of an material distribution task. Other maintenance tasks might be combination tasks—for example, performing a self-diagnosis, determining from the self-diagnosis that an AV component requires repair, and reporting to a designated location where the repair can be made.

An embodiment also generates one or more constraints corresponding to a task. A constraint limits an aspect of the performance of a task. For example, a constraint on an imagery task might be that images must be recorded using a camera having a particular minimum number of pixels or at least a minimum frequency response. Other constraints on an imagery task might be that an image must be recorded from a particular location or point of view or include a minimum or maximum area of coverage. Other constraints on an imagery task might be that the image be recorded when atmospheric visibility is greater than a particular threshold visibility, or when other weather conditions (e.g. temperature, humidity, wind speed, wind direction, etc.) are below certain parameters or exceed certain other parameters. For example, fog can obscure an image, and excessive wind speed can result in excessive movement of an imaging target, leading to blurriness. A constraint on an environment recording task might be that the data must be recorded using a sensor having a particular frequency response range or comprise a minimum or maximum number of data points.

Similarly, a constraint on a sample collection task might be a minimum or maximum number of samples to be collected, a minimum or maximum area or three-dimensional volume surrounding a geographical coordinate from which samples are to be collected, a distribution of sample collection locations within the designated area (e.g. evenly distributed, or using a pseudo-random distribution, or unevenly distributed with a concentration on one or more portions of the designated area), a minimum or maximum sample size or weight, a compatibility of the material to be collected with an actuator performing the collection and with a storage container containing the collected material, and the like. Similarly, a constraint on an material distribution task might be a minimum or maximum amount or weight of material to be distributed, a minimum or maximum area or three-dimensional volume surrounding a geographical coordinate to which material is to be applied, a distribution of application locations within the designated area (e.g. evenly distributed, or using a pseudo-random distribution, or unevenly distributed with a concentration on one or more portions of the designated area), a minimum or maximum material weight to be applied, a compatibility of the material to be applied with an actuator performing the application and with a storage container containing the material to be applied, and the like. A constraint on a maintenance task might be a minimum or maximum time interval between self-check or sensor calibration tests, or a fuel or charge level at which refueling or recharging should be initiated, and the like.

An embodiment analyzes the data obtained by an AV's performance of a task such as an imagery task, environment recording task, sample collection task, or AV maintenance task. As well as using the analysis to determine a state of a physical area being managed or a state of an AV being used for the management, an embodiment uses the analysis results to determine if a task has been acceptably performed (i.e. the data meets task completion criteria), or if the task has not been acceptably performed (i.e. the data does not meet task completion criteria) and must be re-performed. An embodiment analyzes one or more images obtained as part of an imagery task to determine a state of a physical area being managed and to determine if the images satisfy task completion criteria. For example, if the imagery task completion criteria include a minimum number of images, having a threshold quality measure, of a particular object, but heavy rain, a vehicle, or a person or animal obscured the object during imaging, it is likely that there will not be enough unobscured images of the object of a sufficient quality. As a result, the imagery task will have to be re-performed. Similarly, an embodiment analyzes one or more datasets obtained as part of an environment recording task to determine a state of a physical area being managed and to determine if the data satisfy task completion criteria. An embodiment analyzes one or more physical samples obtained as part of a sample collection task to determine a state of a physical area being managed and to determine if the samples satisfy task completion criteria. An embodiment also analyzes any results reported by an AV as part of an AV maintenance task to determine a state of the AV and to determine if the results satisfy task completion criteria. For example, if the maintenance task was to have the AV recharge itself, but the AV reports that it has not attained a charge above a threshold charge within a predetermined time period, the recharge will have to be re-performed.

If an embodiment determines that a task requires re-performance, the embodiment optionally alters a constraint associated with the task. The alteration may be related to analysis of data resulting from the initial performance of the task. For example, if an initial constraint on an imagery task was that an image must be recorded from a particular location or point of view, but from analysis of the resulting image data an embodiment concludes that the particular location or point of view is inaccessible (e.g. if a field is too muddy for safe access), the embodiment might alter the particular location or point of view when re-performing the task. Alternatively, the alteration may not be related to analysis of data resulting from the initial performance of the task.

An embodiment also uses the analysis results to determine if a subsequent task is required. If a subsequent task is required, an embodiment generates the subsequent task and an appropriate corresponding constraint in a manner described herein. In one sequence, an embodiment generates an imagery task. Then, based on an analysis of the images obtained, the embodiment generates a material distribution task. In another sequence, an embodiment generates a sample collection task. Then, based on an analysis of the samples collected, the embodiment generates a material distribution task. In another sequence, an embodiment generates an environment recording task. Then, based on an analysis of the data resulting from performance of the environment recording task, the embodiment generates a material distribution task. For example, in a farm management application, if an embodiment determines, from image analysis, that the plants in a field require additional fertilizer, the embodiment generates a material distribution task in which fertilizer is applied to the field. Similarly, if an embodiment determines, from soil moisture analysis on a collected soil sample, that the plants in a field require additional irrigation, the embodiment generates a material distribution task in which additional irrigation is applied to the field. If an embodiment determines, from environmental measurements, that the soil temperature in a field and air temperature and humidity at a height above the field have all remained within a specified range for more than a specified period of time, the embodiment concludes that conditions are suitable for planting and generates a material distribution task in which plant seeds are applied to the field.

Once an embodiment has generated a task and a constraint corresponding to the task, the embodiment selects a suitable AV to perform the task and cause the selected AV to perform the task. To determine which vehicles are available for the task that match the constraint, an embodiment sends an AV status request to one or more AVs. The request may address a particular AV individually, may address all AVs within communications range of the sender, or may address a subset of all AVs within communications range. As well, the embodiment communicates with an AV through any suitable wired or wireless communications method using any suitable communications protocol. For example, both the embodiment and the AV may be equipped to communicate over a communications network such as the Internet, with the embodiment communicating with the network using a wired connection and the AV communicating with the network using a wireless connection based on a cellular data protocol.

An embodiment receives a response to the AV status request that includes status data from the responding AV. The status data includes an identifier associated with the AV and availability data for the AV.

In one embodiment, the status data also includes data relating to a capability of the AV. One example capability of the AV might be that the AV is an ATV or an AAV. Another example capability of the AV might be that this AV is equipped with a camera having a specified resolution and image storage of a particular size. Another example capability of the AV might be that this AV is equipped with an actuator capable of collecting a physical sample of a defined size range and weight range, and sufficient storage for a particular number and weight of physical samples. Another example capability of the AV might be that this AV is equipped with an actuator capable of applying a material of a defined size range and weight range, and sufficient storage for a particular volume or weight of material to be applied. Another example capability of the AV might be that this AV is equipped with an actuator or storage capability capable of collecting or dispersing a material having a particular characteristic—for example, a material having a particular range of corrosiveness or biohazard level. Another embodiment obtains AV capability data from another source such as a database or compendium of AV capabilities.

Availability data for the AV includes a report that the AV is available to perform a task, or that the AV is not available to perform a task. Availability data may also include information from which the embodiment concludes that while the AV is not currently available, the AV could be available once an AV maintenance task is successfully performed. For example, the AV may report that requires recharging, refueling, or a reload of material to be dispersed.

If one AV is available and meets one or more constraints corresponding to a task, the embodiment selects the AV. If more than one AV is available and meets one or more constraints corresponding to a task, the embodiment selects the AV that best meets any constraints, or selects any one of the AVs that meet the constraints. Techniques for selecting the AV that best meets any constraints are known to those of ordinary skill in the art and the same are contemplated within the scope of the illustrative embodiments. The embodiment sends data to the selected AV causing the selected AV to perform the task according to any task constraints. The embodiment also receives any task results from the AV.

If no AV is available that meets one or more constraints corresponding to a task, but the embodiment has concluded that one or more such AVs could be made available, the embodiment selects, in a manner described herein, an AV to be made available. The embodiment generates an AV maintenance task and corresponding maintenance constraint relating to the AV to be made available, and causes a suitable AV to perform the task in a manner described herein. Such an AV maintenance task might be, for example, that AV to be made available should connect itself to a recharging port, or that another AV should deliver additional physical material to the AV to be made available.

The manner of intelligent area and dispersal management using autonomous vehicles described herein is unavailable in the presently available methods in the technological field of endeavor pertaining to management of a physical area using autonomous vehicles. A method of an embodiment described herein, when implemented to execute on a device or data processing system, comprises substantial advancement of the functionality of that device or data processing system in generating a task and a constraint on the task, causing an autonomous vehicle according to the constraint to perform the task, analyzing a result of the task, generating a subsequent task and corresponding constraint based on the analysis of the results of the first task, and causing an autonomous vehicle according to the subsequent constraint to perform the subsequent task.

The illustrative embodiments are described with respect to certain types of tasks, AVs, AV capabilities, periods, ranges, thresholds, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

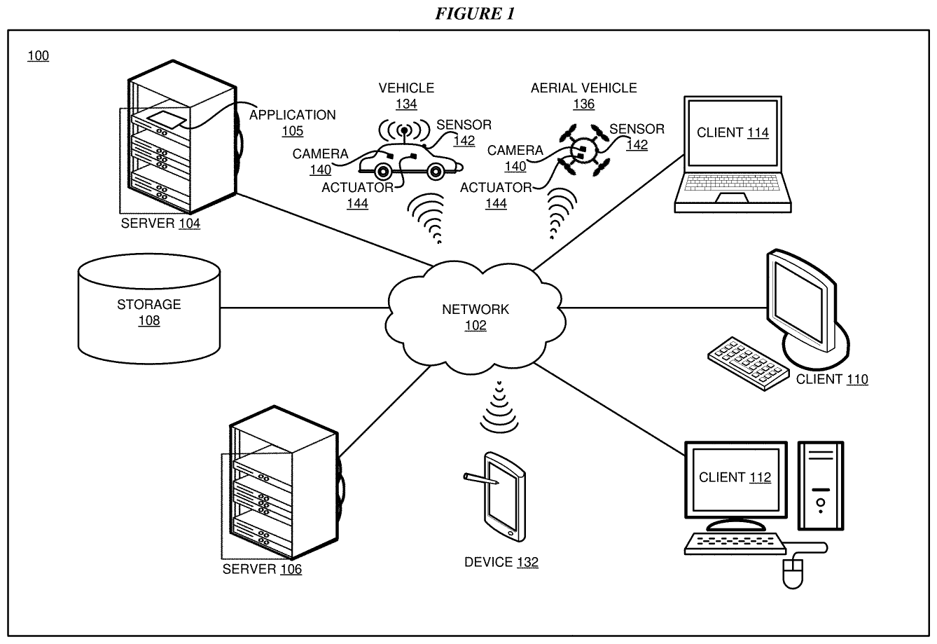

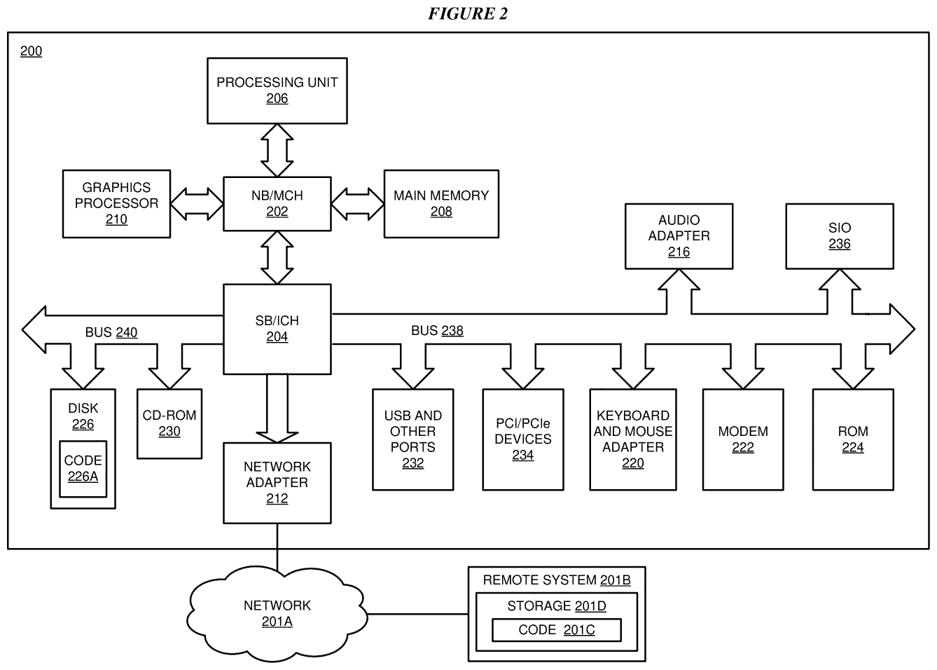

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Vehicle 134 and aerial vehicle 136 are examples of an autonomous vehicle described herein. In particular, vehicle 134 is an example of an ATV and aerial vehicle 136 is an example of an AAV. Each of vehicle 134 and aerial vehicle 136 include camera 140, environmental sensor 142, and actuator 144. Camera 140 is suitable for recording images of an environment around vehicle 134 or aerial vehicle 136. Optionally, camera 140 can record video as well as still images. Environmental sensor 142 is suitable for recording an aspect of an environment around vehicle 134 or aerial vehicle 136. Environmental sensor 142 can be a sound sensor, electromagnetic signal sensor, temperature sensor, moisture sensor, or another type of sensor. Actuator 144 is suitable for collecting a physical sample of a portion of an environment around vehicle 134 or aerial vehicle 136 or applying a physical material to a portion of an environment around vehicle 134 or aerial vehicle 136.

Application 105 implements an embodiment described herein. Application 105 generates tasks and causes vehicle 134 or aerial vehicle 136 to execute the generated tasks according to corresponding task constraints. Application 105 also analyzes data obtained by vehicle 134 or aerial vehicle 136.

Servers 104 and 106, storage unit 108, clients 110, 112, and 114, vehicle 134, aerial vehicle 136, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 or applications controlling vehicle 134 and aerial vehicle 136 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

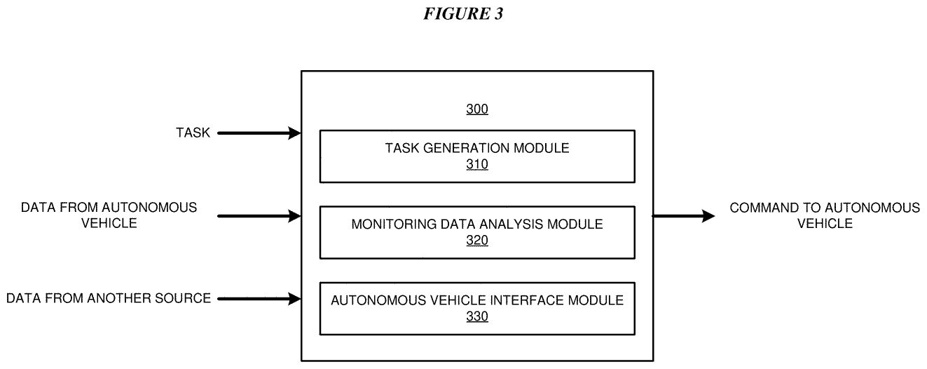

With reference to FIG. 3, this figure depicts a block diagram of an example configuration for intelligent area and dispersal management using autonomous vehicles in accordance with an illustrative embodiment. Application 300 is an example of application 105 in FIG. 1 and executes in any of servers 104 and 106, clients 110, 112, and 114, and device 132 in FIG. 1.

Task generation module 310 generates a set of tasks to be performed by an autonomous vehicle, such as vehicle 134 or aerial vehicle 136 in FIG. 1. Task generation module 310 also accepts a task from a user, and if necessary generates a corresponding set of more detailed tasks from the user task. Along with each task, task generation module 310 generates one or more constraints corresponding to the task.

Monitoring data analysis module 320 analyzes the data obtained by an AV's performance of a task such as an imagery task, environment recording task, sample collection task, or AV maintenance task. As well as using the analysis to determine a state of a physical area being managed or a state of an AV being used for the management, module 320 uses the analysis results to determine if a task has been acceptably performed (i.e. the data meets task completion criteria), or if the task has not been acceptably performed (i.e. the data does not meet task completion criteria) and must be re-performed. If the task requires re-performance, task generation module 310 regenerates the task, optionally with an altered task constraint. Module 320 uses the analysis results to determine if a subsequent task is required. If a subsequent task is required, task generation module 310 generates the subsequent task and an appropriate corresponding constraint.

Autonomous vehicle interface module 330 communicates with AVs, such as vehicle 134 or aerial vehicle 136 in FIG. 1. To determine which vehicles are available for the task that match the constraint, module 330 sends an AV status request to one or more AVs. Module 330 receives a response to the AV status request that includes status data from the responding AV. The status data includes an identifier associated with the AV and availability data for the AV. The status data may also include data relating to a capability of the AV; if not, module 330 obtains data relating to a capability of the AV from another source such as a database of AV capabilities. Availability data for the AV includes a report that the AV is available to perform a task, or that the AV is not available to perform a task. Availability data may also include information from which the embodiment concludes that while the AV is not currently available, the AV could be available once an AV maintenance task is successfully performed. Module 330 selects an AV meeting one or more constraints corresponding to a task, causes the AV to perform the task according to any task constraints, and receives any task results from the AV.

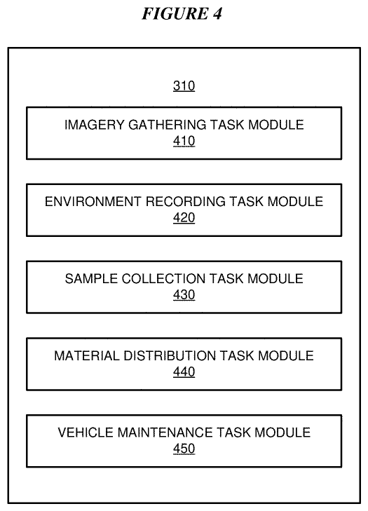

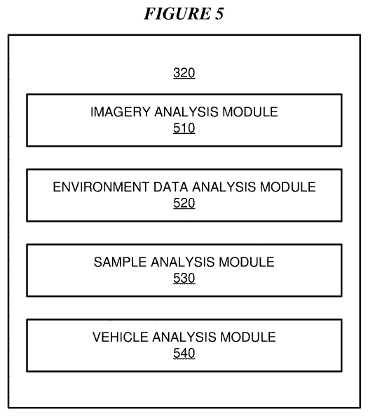

With reference to FIG. 4, this figure depicts a block diagram of an example configuration for intelligent area and dispersal management using autonomous vehicles in accordance with an illustrative embodiment. In particular, FIG. 4 depicts more detail of module 310 in FIG. 3.

Imagery gathering task module 410 generates an imagery task and corresponding constraint. An imagery task causes an autonomous vehicle, such as vehicle 134 or aerial vehicle 136 in FIG. 1, to record, using a sensor of the autonomous vehicle, an image of an environment around the autonomous vehicle.

Environment recording task module 420 generates an environment recording task and corresponding constraint. An environment recording task causes an autonomous vehicle, such as vehicle 134 or aerial vehicle 136 in FIG. 1, to record, using a sensor of the autonomous vehicle, an aspect of an environment around the autonomous vehicle.

Sample collection task module 430 generates a sample collection task and corresponding constraint. A sample collection task causes an autonomous vehicle, such as vehicle 134 or aerial vehicle 136 in FIG. 1, to collect a physical sample of a portion of an environment around the autonomous vehicle. Depending on the capabilities of the autonomous vehicle, the AV can return the sample to a designated area for further analysis or perform the analysis at the collection site.

Material distribution task module 440 generates a material distribution task and corresponding constraint. A material distribution task causes an autonomous vehicle, such as vehicle 134 or aerial vehicle 136 in FIG. 1, to apply a physical material to a portion of an environment around the autonomous vehicle or to modify a portion of an environment around the autonomous vehicle.

Vehicle maintenance task module 450 generates an AV maintenance task and corresponding constraint. An AV maintenance task cause an autonomous vehicle, such as vehicle 134 or aerial vehicle 136 in FIG. 1, to perform a maintenance task on itself, or to proceed to a designated area where a human or another system can perform maintenance on the AV.

With reference to FIG. 5, this figure depicts a block diagram of an example configuration for intelligent area and dispersal management using autonomous vehicles in accordance with an illustrative embodiment. In particular, FIG. 5 depicts more detail of module 320 in FIG. 3.

Imagery analysis module 510 analyzes one or more images obtained as part of an imagery task to determine a state of a physical area being managed and to determine if the images satisfy task completion criteria. Environment data analysis module 520 analyzes one or more datasets obtained as part of an environment recording task to determine a state of a physical area being managed and to determine if the data satisfy task completion criteria. Sample analysis module 530 analyzes one or more physical samples obtained as part of a sample collection task to determine a state of a physical area being managed and to determine if the samples satisfy task completion criteria. Vehicle analysis module 540 analyzes any results reported by an AV as part of an AV maintenance task to determine a state of the AV and to determine if the results satisfy task completion criteria.

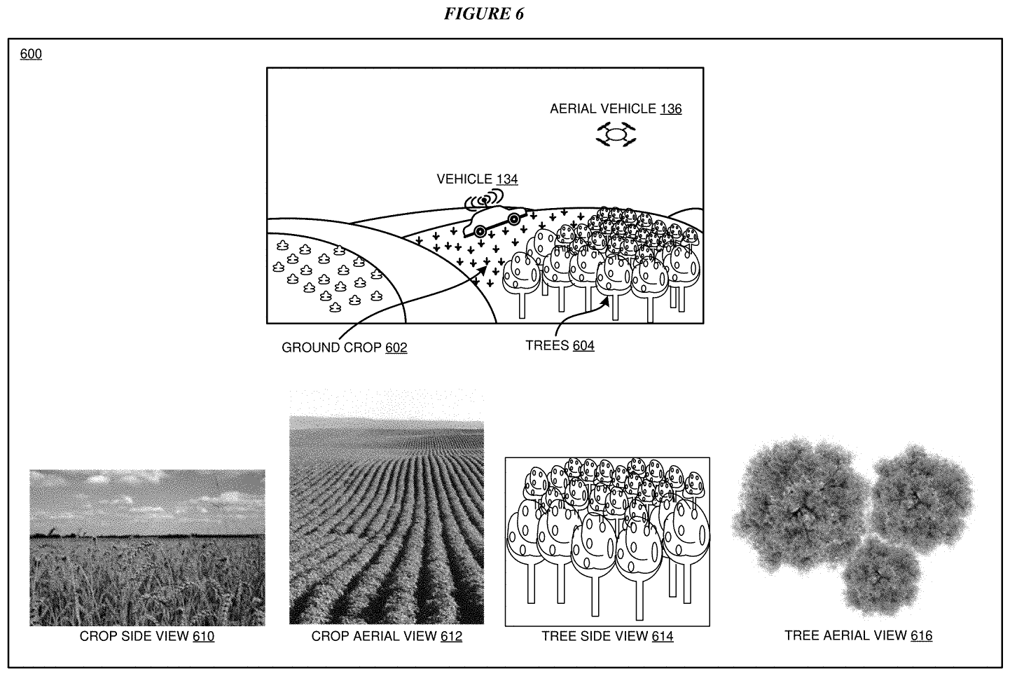

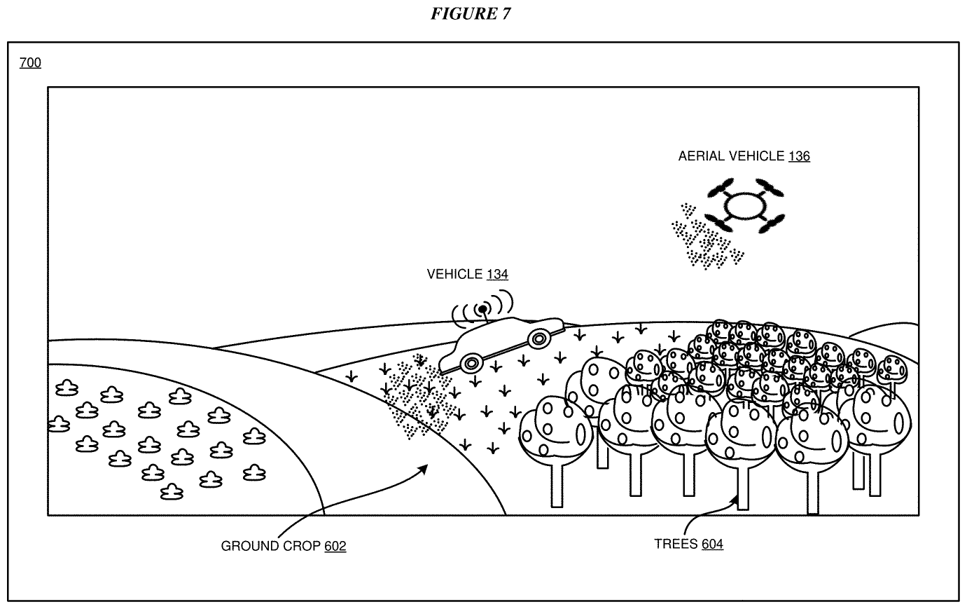

With reference to FIG. 6, this figure depicts an example of intelligent area and dispersal management using autonomous vehicles in accordance with an illustrative embodiment. Vehicle 134 and aerial vehicle 136 are the same as vehicle 134 and aerial vehicle 136 in FIG. 1 and communicate with application 300 in FIG. 3.

In this example, application 300 generates imagery task 1: to obtain an image of the plants in field A. A constraint on imagery task 1 is that the image be a side view, from a point of view one meter above the soil surface. Application 300 determines that vehicle 134, an ATV, has a camera of a suitable quality, is capable of autonomously placing itself at the required location and recording the required image from the point of view, and is available for use. Accordingly, application 300 causes vehicle 134 to perform imagery task 1 according to the corresponding constraint. Vehicle 134 autonomously performs imagery task 1 and returns an image such as crop side view 610.

As another example, application 300 generates imagery task 2: to obtain an image of the plants in field A. A constraint on imagery task 2 is that the image be an overhead view, from a point of view ten meters above the soil surface. Application 300 determines that aerial vehicle 136, an AAV, has a camera of a suitable quality, is capable of placing itself at the required location and recording the required image from the point of view, and is available for use. Accordingly, application 300 causes aerial vehicle 136 to perform imagery task 2 according to the corresponding constraint. Aerial vehicle 136 performs imagery task 2 and returns an image such as crop aerial view 620.

As another example, application 300 generates imagery task 3: to obtain an image of the trees in orchard B. A constraint on imagery task 3 is that the image be a side view, from a point of view one meter above the soil surface. Application 300 determines that vehicle 134, an ATV, has a camera of a suitable quality, is capable of placing itself at the required location and recording the required image from the point of view, and is available for use. Accordingly, application 300 causes vehicle 134 to perform imagery task 3 according to the corresponding constraint. Vehicle 134 performs imagery task 3 and returns an image such as tree side view 630.

As another example, application 300 generates imagery task 4: to obtain an image of the trees in orchard B. A constraint on imagery task 4 is that the image be an overhead view, from a point of view ten meters above the soil surface. Application 300 determines that aerial vehicle 136, an AAV, has a camera of a suitable quality, is capable of placing itself at the required location and recording the required image from the point of view, and is available for use. Accordingly, application 300 causes aerial vehicle 136 to perform imagery task 4 according to the corresponding constraint. Aerial vehicle 136 performs imagery task 4 and returns an image such as tree aerial view 640.

With reference to FIG. 7, this figure depicts another example of intelligent area and dispersal management using autonomous vehicles in accordance with an illustrative embodiment. Vehicle 134 and aerial vehicle 136 are the same as vehicle 134 and aerial vehicle 136 in FIG. 1 and communicate with application 300 in FIG. 3.

In this example, application 300 generates material distribution task 1: to distribute fertilizer to ground crop 602. A constraint on material distribution task 1 is that the fertilizer be applied to the soil surface, within a specified distance of where stems of the plants in field A emerge from the soil. Application 300 determines that vehicle 134, an ATV, has an actuator suitable for dispersing the required material and a storage capability suitable for holding the required material before dispersal, is capable of placing itself at the required location and applying the material to the correct location, and is available for use. Accordingly, application 300 causes vehicle 134 to perform material distribution task 1 according to the corresponding constraint. Vehicle 134 performs material distribution task 1 and reports task completion to application 300.

As another example, application 300 generates material distribution task 2: to distribute a protective material to trees 604. A constraint on material distribution task 1 is that the protective material be applied to the tops of trees 604, from above. Application 300 determines that aerial vehicle 136, an AAV, has an actuator suitable for dispersing the required material and a storage capability suitable for holding the required material before dispersal, is capable of placing itself at the required location and applying the material to the correct location, and is available for use. Accordingly, application 300 causes aerial vehicle 136 to perform material distribution task 2 according to the corresponding constraint. Aerial vehicle 136 performs material distribution task 2 and reports task completion to application 300.

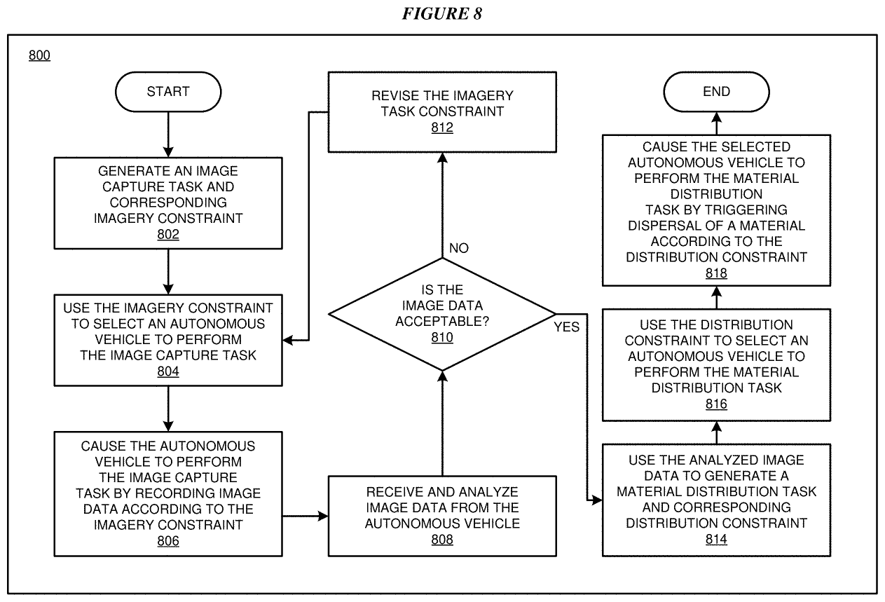

With reference to FIG. 8, this figure depicts a flowchart of an example process for intelligent area and dispersal management using autonomous vehicles in accordance with an illustrative embodiment. Process 800 can be implemented in application 300 in FIG. 3.

In block 802, the application generates an image capture task and corresponding imagery constraint. In block 804, the application uses the imagery constraint to select an autonomous vehicle to perform the image capture task. In block 806, the application causes the selected autonomous vehicle to perform the image capture task by recording image data according to the imagery constraint. In block 808, the application receives and analyzes image data from the autonomous vehicle. In block 810, the application checks whether the image data is acceptable—i.e., the image data meets task completion criteria. If not (“NO” path of block 810), in block 812 the application revises the imagery task constraint, then returns to block 804 to re-perform the imagery task. If yes (“YES” path of block 810), in block 814 the application uses the analyzed image data to generate a material distribution task and corresponding distribution constraint. In block 816, the application uses the distribution constraint to select an autonomous vehicle to perform the material distribution task. In block 818, the application causes the selected autonomous vehicle to perform the material distribution task by triggering dispersal of a material according to the distribution constraint. Then the application ends.

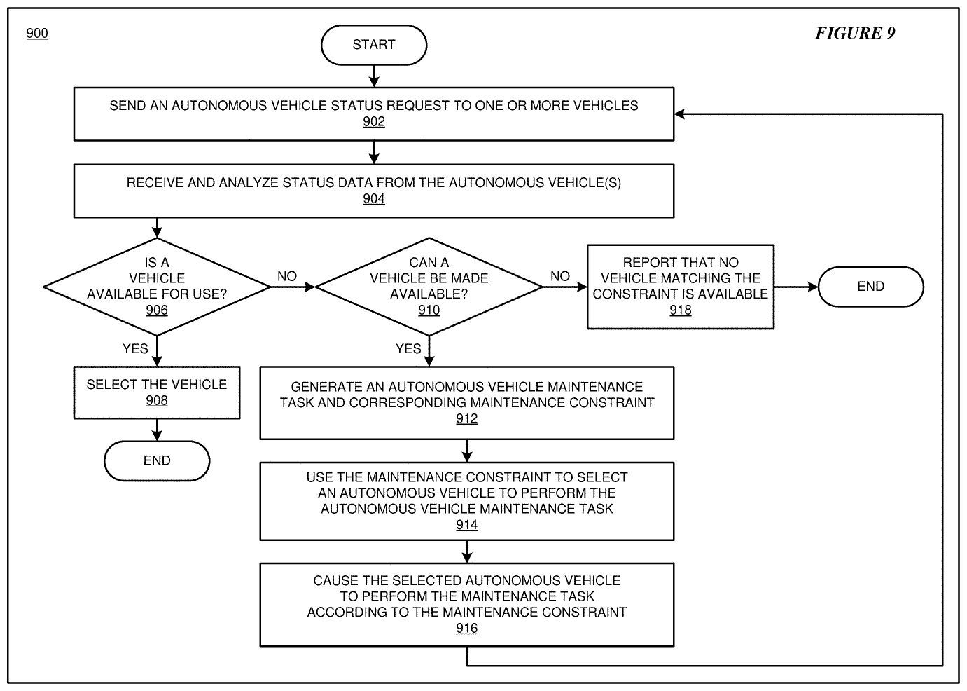

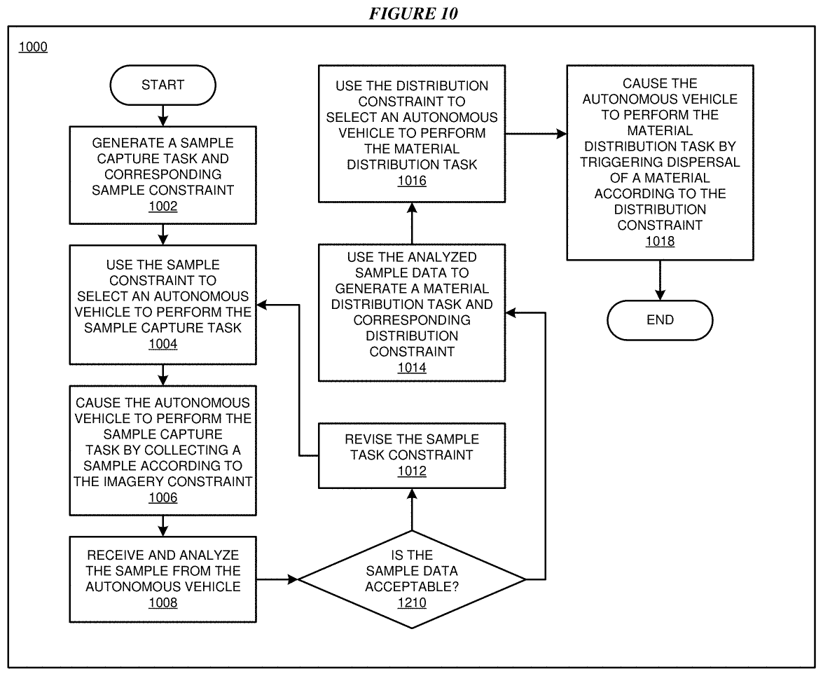

With reference to FIG. 9, this figure depicts another flowchart of an example process for intelligent area and dispersal management using autonomous vehicles in accordance with an illustrative embodiment. Process 900 can be implemented in application 300 in FIG. 3.

In block 902, the application sends an autonomous vehicle status request to one or more AVs. In block 904, the application receives and analyze status data from the autonomous vehicle(s). In block 906, the application determines whether, based on the status data, an AV meeting a task constraint is available for use in performing that task. If yes (“YES” path of block 906), in block 908 the application selects the AV, then sends. Otherwise (“NO” path of block 906), in block 910 the application determines whether an AV meeting a task constraint can be made available for use in performing that task. If not (“NO” path of block 910), in block 918 the application reports that no vehicle matching the constraint is available, then ends. Otherwise (“YES” path of block 910), in block 912 the application generates an autonomous vehicle maintenance task and corresponding maintenance constraint. In block 914, the application uses the maintenance constraint to select an autonomous vehicle to perform the autonomous vehicle maintenance task. In block 916, the application causes the selected autonomous vehicle to perform the maintenance task according to the maintenance constraint. Then the application ends. With reference to FIG. 10, this figure depicts a flowchart of an example process for intelligent area and dispersal management using autonomous vehicles in accordance with an illustrative embodiment. Process 1000 can be implemented in application 300 in FIG. 3. In block 1002, the application generates an sample capture task and corresponding sample constraint. In block 1004, the application uses the sample constraint to select an autonomous vehicle to perform the sample capture task. In block 1006, the application causes the selected autonomous vehicle to perform the sample capture task by collecting a sample according to the sample constraint. In block 1008, the application receives and analyzes sample data from the autonomous vehicle. In block 1010, the application checks whether the sample data is acceptable—i.e., the sample data meets task completion criteria. If not (“NO” path of block 1010), in block 1012 the application revises the sample task constraint, then returns to block 1004 to re-perform the sample task. If yes (“YES” path of block 1010), in block 1014 the application uses the analyzed sample data to generate a material distribution task and corresponding distribution constraint. In block 1016, the application uses the distribution constraint to select an autonomous vehicle to perform the material distribution task. In block 1018, the application causes the selected autonomous vehicle to perform the material distribution task by triggering dispersal of a material according to the distribution constraint. Then the application ends.

Thus, a computer implemented method, system or apparatus, and computer program product are provided in the illustrative embodiments for intelligent area and dispersal management using autonomous vehicles and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
selecting, using an imagery task constraint corresponding to an image capture task, an autonomous vehicle (AV) to perform the image capture task;
causing the autonomous vehicle to perform the image capture task according to the imagery task constraint, performing the image capture task comprising causing the AV to autonomously record image data of an area in a field of view of the AV;
receiving, from the AV, image data responsive to the imagery task;
generating, from an analysis of the image data using a processor and a memory, a material distribution task and a corresponding distribution task constraint;
selecting, using the distribution task constraint, a second AV to perform the material application task; and
causing the second AV to perform the material distribution task according to the distribution task constraint, performing the material distribution task comprising causing the autonomous vehicle to autonomously trigger dispersal of a material in an area in a field of view of the autonomous vehicle.

2. The method of claim 1, further comprising:
generating, using an agricultural information database, the image capture task and the imagery task constraint.

3. The method of claim 1, further comprising:
generating, from a user request, the image capture task and the imagery task constraint.

4. The method of claim 1, further comprising:
revising, based on the analysis of the image data, the imagery task constraint;
selecting, using the revised imagery task constraint, a third AV to perform the image capture task;
causing the third AV to perform the image capture task according to the revised imagery task constraint; and
receiving, from the third AV, image data responsive to the image capture task.

5. The method of claim 1, further comprising:
generating an environment recording task and a corresponding environment recording task constraint;
selecting, using the environment recording task constraint, a third AV to perform the environment recording task;
causing the third AV to perform the environment recording task according to the environment recording task constraint, performing the environment recording task comprising causing the third AV to record environment data of a portion of an environment surrounding the AV;
receiving, from the third AV, environment data responsive to the environment recording task;
generating, from an analysis of the environment data using a processor and a memory, a material distribution task and a distribution task constraint corresponding to the material distribution task;
selecting, using the distribution task constraint, a fourth AV to perform the material application task; and
causing the fourth AV to perform the material distribution task according to the distribution task constraint, performing the material distribution task comprising causing the fourth AV to autonomously trigger dispersal of a material in an area in a field of view of the autonomous vehicle.

6. The method of claim 5, further comprising:
revising, based on the analysis of the environment data, the environment recording task constraint;
selecting, using the revised environment recording task constraint, a third AV to perform the environment recording task;
causing the third AV to perform the environment recording task according to the revised environment recording task constraint; and
receiving, from the third AV, environment data responsive to the environment recording task.

7. The method of claim 1, further comprising:
generating a sample collection task and a corresponding sample collection task constraint;
selecting, using the sample collection task constraint, a third AV to perform the sample collection task;
causing the third AV to perform the sample collection task according to the sample collection task constraint, performing the sample collection task comprising causing the third AV to collect a physical sample of an environment surrounding the autonomous vehicle;
receiving, from the third AV, the physical sample;
generating, from an analysis of the physical sample using a processor and a memory, a material distribution task and a distribution task constraint corresponding to the material distribution task;
selecting, using the distribution task constraint, a fourth AV to perform the material application task; and
causing the fourth AV to perform the material distribution task according to the distribution task constraint, performing the material distribution task comprising causing the fourth autonomous vehicle to autonomously trigger dispersal of a material in an area in a field of view of the fourth autonomous vehicle.

8. The method of claim 7, further comprising:
revising, based on the analysis of the physical sample, the sample collection task constraint;
selecting, using the revised sample collection task constraint, a fifth AV to perform the sample collection task;
causing the fifth AV to perform the sample collection task according to the revised sample collection task constraint; and
receiving, from the fifth AV, a second physical sample responsive to the sample collection task.

9. The method of claim 1, further comprising:
generating, responsive to performance of the material distribution task, a second image capture task and a second imagery task constraint corresponding to the second image capture task.

10. The method of claim 1, further comprising:
generating, responsive to receiving autonomous vehicle status data, a vehicle maintenance task and a maintenance constraint corresponding to the vehicle maintenance task;
selecting, using the maintenance constraint, a third AV to perform the vehicle maintenance task;
causing the third AV to perform the vehicle maintenance task according to the maintenance task constraint.

11. The method of claim 1, wherein the imagery task constraint comprises a specification of a type of autonomous vehicle.

12. The method of claim 1, wherein the material distribution task constraint comprises a specification of a type of autonomous vehicle.

13. A computer usable program product comprising one or more computer-readable storage devices, and program instructions stored on at least one of the one or more storage devices, the stored program instructions comprising:
program instructions to select, using an imagery task constraint corresponding to an image capture task, an autonomous vehicle (AV) to perform the image capture task;
program instructions to cause the autonomous vehicle to perform the image capture task according to the imagery task constraint, performing the image capture task comprising causing the AV to autonomously record image data of an area in a field of view of the AV;
program instructions to receive, from the AV, image data responsive to the imagery task;
program instructions to generate, from an analysis of the image data using a processor and a memory, a material distribution task and a distribution task constraint corresponding to the material distribution task;
program instructions to select, using the distribution task constraint, a second AV to perform the material application task; and
program instructions to cause the second AV to perform the material distribution task according to the distribution task constraint, performing the material distribution task comprising causing the autonomous vehicle to autonomously trigger dispersal of a material in an area in a field of view of the autonomous vehicle.

14. The computer usable program product of claim 13, further comprising:
program instructions to generate, using an agricultural information database, the image capture task and the imagery task constraint.

15. The computer usable program product of claim 13, further comprising:
program instructions to generate, from a user request, the image capture task and the imagery task constraint.

16. The computer usable program product of claim 13, further comprising:
program instructions to revise, based on the analysis of the image data, the imagery task constraint;
program instructions to select, using the revised imagery task constraint, a third AV to perform the image capture task;
program instructions to cause the third AV to perform the image capture task according to the revised imagery task constraint; and
program instructions to receive, from the third AV, image data responsive to the image capture task.

17. The computer usable program product of claim 13, further comprising:
program instructions to generate an environment recording task and a corresponding environment recording task constraint;
program instructions to select, using the environment recording task constraint, a third AV to perform the environment recording task;
program instructions to cause the third AV to perform the environment recording task according to the environment recording task constraint, performing the environment recording task comprising causing the third AV to record environment data of a portion of an environment surrounding the AV;
program instructions to receive, from the third AV, environment data responsive to the environment recording task;
program instructions to generate, from an analysis of the environment data using a processor and a memory, a material distribution task and a distribution task constraint corresponding to the material distribution task;
program instructions to select, using the distribution task constraint, a fourth AV to perform the material application task; and
program instructions to cause the fourth AV to perform the material distribution task according to the distribution task constraint, performing the material distribution task comprising causing the fourth AV to autonomously trigger dispersal of a material in an area in a field of view of the autonomous vehicle.

18. The computer usable program product of claim 13, wherein the computer usable code is stored in a computer readable storage device in a data processing system, and wherein the computer usable code is transferred over a network from a remote data processing system.

19. The computer usable program product of claim 13, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to select, using an imagery task constraint corresponding to an image capture task, an autonomous vehicle (AV) to perform the image capture task;
program instructions to cause the autonomous vehicle to perform the image capture task according to the imagery task constraint, performing the image capture task comprising causing the AV to autonomously record image data of an area in a field of view of the AV;
program instructions to receive, from the AV, image data responsive to the imagery task;
program instructions to generate, from an analysis of the image data using a processor and a memory, a material distribution task and a distribution task constraint corresponding to the material distribution task;
program instructions to select, using the distribution task constraint, a second AV to perform the material application task; and
program instructions to cause the second AV to perform the material distribution task according to the distribution task constraint, performing the material distribution task comprising causing the autonomous vehicle to autonomously trigger dispersal of a material in an area in a field of view of the autonomous vehicle.
